(19) United States
(12) Patent Application Publication
(10) Pub. No.: US 2014/0146706 A1
(43) Pub. Date: May 29, 2014

(54) APPARATUS AND METHOD FOR INTEGRATED ROUTING IN MULTI-NETWORK

(71) Applicant: Electronics and Telecommunications Research Institute, Daejeon (KR)

(72) Inventors: Hyung Seok CHUNG, Daejeon (KR); Ho Young SONG, Daejeon (KR); You Hyeon JEONG, Daejeon (KR)

(73) Assignee: Electronics and Telecommunications Research Institute, Daejeon (KR)

(21) Appl. No.: 14/086,516

(22) Filed: Nov. 21, 2013

(30) Foreign Application Priority Data
Nov. 27, 2012 (KR) 10-2012-0135573

(51) Int. Cl. H04L 12/751

(52) U.S. Cl. CPC H04L 45/02
USPC 370/254

(57) ABSTRACT

An apparatus for integrally managing a route between terminals of a multi-network and a method of setting a route between terminals of a multi-network are provided. The integrated route management system apparatus includes: a network route management processor that manages a route that is included in an individual network of the multi-network; a route state and performance monitoring unit that collects information about a route state and route performance from a network node that is included in the route; and an integrated route management processor that sets a route between terminals of the multi-network based on a route that is included in the individual network.

### CROSS-REFERENCE TO RELATED APPLICATION

This application claims priority to and the benefit of Korean Patent Application No. 10-2012-0135573 filed in the Korean Intellectual Property Office on Nov. 27, 2012, the entire contents of which are incorporated herein by reference.

### BACKGROUND OF THE INVENTION

(a) Field of the Invention

The present invention relates to a method and apparatus for integrated routing of a network. More particularly, the present invention relates to a method of integrated routing between terminals of a multi-network and collecting and managing state and performance information of a preset route.

(b) Description of the Related Art

In general, a communication provider divides a network to be a service providing target into a backbone network, a metro network, and an access network, and manages it. Therefore, when the communication provider provides a network service to a user, the communication provider sets a route through respective network management systems and monitors a traffic state.

In a general multi-network, a route between users is set via a network such as an access network, a metro network, and a backbone network.

An access route exists in the access network, a metro route exists in the metro network, and a backbone route exists in the backbone network. In the access network, the metro network, and the backbone network, respective management systems exist and perform setting, state monitoring, and route performance monitoring functions of a route that is included in each network.

Conventionally, a route in each interval within a network is set with a combination between management systems that are connected to each network. That is, routing in an access network interval that connects users is performed by a combination of routes that are each set by an access network management system, a metro network management system, and a backbone network management system. Finally, by combining routes of corresponding intervals that are set by an access network management system, a metro network management system, and a backbone network management system in response to a routing request of a network service user, a route of an access network interval that connects users is set.

Such a distributed network management system adds a burden from human power and operation cost viewpoint, and there is a problem that service providing time is delayed.

### SUMMARY OF THE INVENTION

The present invention has been made in an effort to provide an integrated route management system apparatus of a multi-network and a method of setting a route between terminals of a multi-network having advantages of providing a function that can integrally set, change, and transmit a route between terminals of the multi-network, monitor a state and performance, rapidly provide various services to a user, and reduce a maintenance cost of the network.

An exemplary embodiment of the present invention provides an apparatus for integrally managing a route between terminals of a multi-network. The integrated route management system apparatus of the multi-network includes: a network route management processor that manages a route that is included in an individual network of the multi-network; a route state and performance monitoring unit that collects information about a route state and route performance from a network node that is included in the route; and an integrated route management processor that sets a route between terminals of the multi-network based on a route that is included in the individual network.

The network route management processor may manage an access route that is included in an access network of the multi-network by setting, changing, or deleting a virtual LAN connection of the access network.

The network route management processor may manage a metro route that is included in a metro network of the multi-network by setting, changing, or deleting a packet transmission route of a line level based on connection-oriented carrier Ethernet technology.

The network route management processor may manage the metro route in a centralized type or a distributed type according to a network operation policy.

The network route management processor may manage a backbone route that is included in a backbone network of the multi-network by setting, changing, or deleting a label exchange route or an optical transmission route.

The route state and performance monitoring unit may periodically collect and store information about the route state or route performance.

The integrated route management processor may determine an optimal route of an individual network in order of a backbone network, a metro network, and an access network of the multi-network when a user of a network service requests a network service, and set a route between terminals based on the optimal route.

The integrated route management processor may receive information about a route between terminals including information about a route state or route performance from the route state and performance monitoring unit and provide the information to a user when a user of a network service requests inquiry of a network QoS.

Another embodiment of the present invention provides a method of setting a route between terminals through a multi-network integrated route management system apparatus. The method includes: receiving, by an integrated route management processor of the integrated route management system apparatus, a preset optimal route of the individual network from a network route management processor of the integrated route management system apparatus; and setting a route between terminals of the multi-network by combining the preset optimal route.

The optimal route of the individual network may be set based on a route situation of the individual network in which the network route management processor of the integrated route management system apparatus determines.

Yet another embodiment of the present invention provides a method of inquiring a network QoS through a multi-network integrated route management system apparatus. The method includes: periodically collecting, by a route state and performance monitoring unit of the integrated route management system apparatus, information about a route state and route performance from a network node of the multi-network; and providing, when a request for a network QoS inquiry of a network user exists, information about a route between terminals including the collected information.

### BRIEF DESCRIPTION OF THE DRAWINGS

FIG. 1 is a diagram illustrating a multi-network to which a multi-network integrated management system apparatus is connected according to an exemplary embodiment of the present invention.

FIG. 2 is a block diagram illustrating a multi-network integrated management system apparatus according to an exemplary embodiment of the present invention.

FIG. 3 is a flowchart illustrating a method of setting a route between terminals of a network through a multi-network integrated management system apparatus according to an exemplary embodiment of the present invention.

FIG. 4 is a flowchart illustrating a method of inquiring a QoS through a multi-network integrated management system apparatus according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, in the specification and claims, unless explicitly described to the contrary, the word “comprise” and variations such as “comprises” or “comprising” will be understood to imply the inclusion of stated elements but not the exclusion of any other elements. The terms such as “-unit”, “-er/-or”, “-module”, and “-block” stated in the specification may signify a processor to process at least one function or operation, and may be embodied by hardware, software, or a combination of hardware and software.

Hereinafter, a method and system for setting an integrated route of a multi-network according to an exemplary embodiment of the present invention will be described in detail with reference to the drawings.

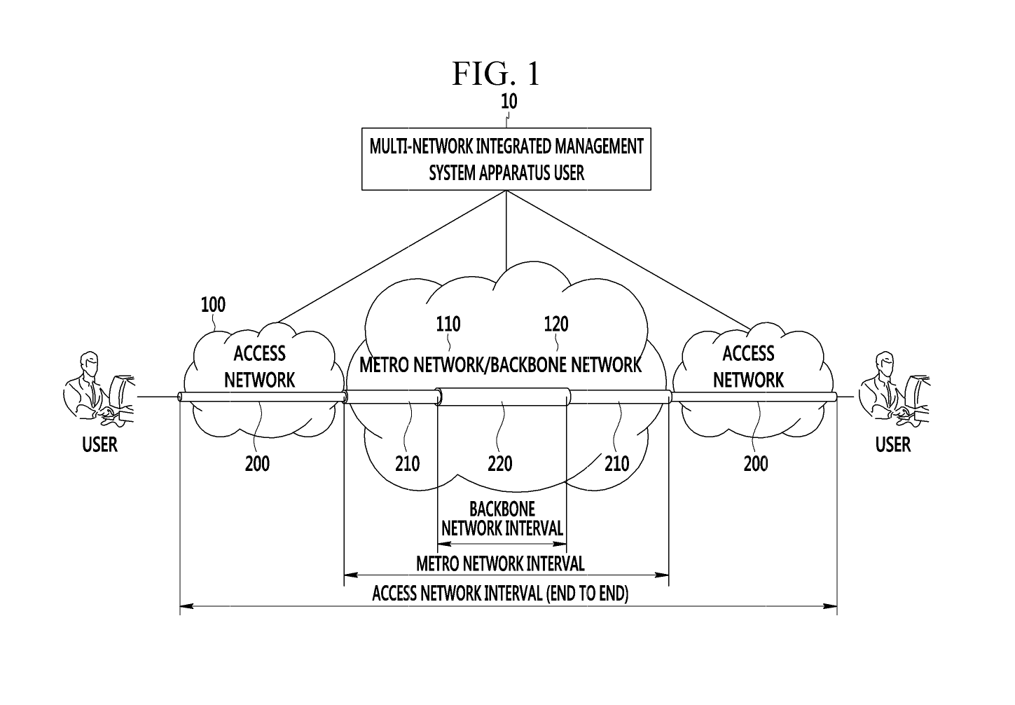

FIG. 1 is a diagram illustrating a multi-network to which a multi-network integrated management system apparatus is connected according to an exemplary embodiment of the present invention.

Referring to FIG. 1, a route between users is set through an access network 100, a metro network 110, and a backbone network 120. An access route 200 exists at the access network 100, a metro route 210 exists at the metro network 110, and a backbone route 220 exists at the backbone network 120. A route of an access network interval that connects users is set by a combination of the access route 200, the metro route 210, and the backbone route 220.

In this case, all of the access network 100, the metro network 110, and the backbone network 120, which are each individual networks that are included in the multi-network, are connected to a multi-network integrated management system apparatus 10, and thus a route on a network that connects users according to a user's routing request is set through the multi-network integrated management system apparatus 10.

Further, the multi-network integrated management system apparatus 10 performs route state monitoring and route performance monitoring functions of a route that is set on a multi-network, and integrally manages a route of an individual network.

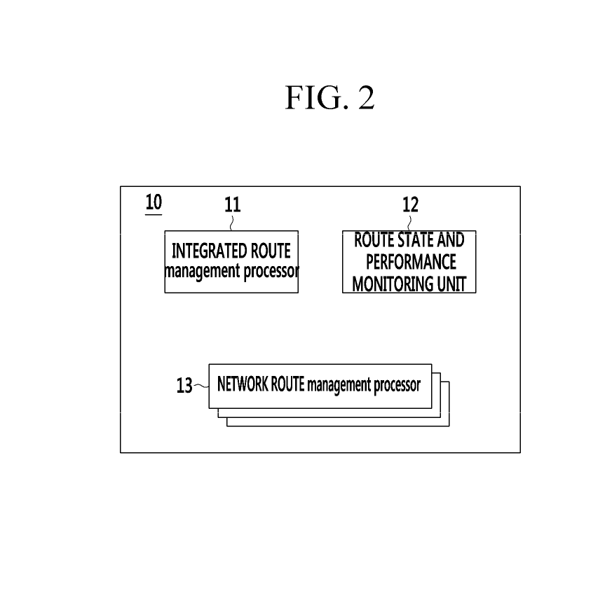

FIG. 2 is a block diagram illustrating a multi-network integrated management system apparatus according to an exemplary embodiment of the present invention.

Referring to FIG. 2, the multi-network integrated management system apparatus 10 includes an integrated route management processor 11, a route state and performance monitoring unit 12, and a network route management processor 13.

The integrated route management processor 11 manages a route list on an individual network basis, and manages a route that is formed in a multi-network by managing a correlation between routes (e.g., the access route 200, the metro route 210, and the backbone route 220) that are included in each network.

The integrated route management processor 11 determines an available route of a network according to a user's service request by managing an interface with a network user, and sets an optimal route that connects terminals of the network. In this case, to determine an available route of the network, an available route is determined in order of a central network to an end network, for example, in order of the backbone network 120, the next metro network 110, and the next access network 100, and an optimal route is set.

After an optimal route is set, when a situation of a route error occurs, the integrated route management processor 11 requests generation of a new route to the network route management processor 13. Further, when the user requests a service inquiry, the integrated route management processor 11 receives information about a state and performance of a present network from the route state and performance monitoring unit 12 and provides the information to the user.

The route state and performance monitoring unit 12 monitors a state and performance of a present network. In this case, the route state and performance monitoring unit 12 periodically collects and stores information about a route state and performance from network nodes.

When a request of the integrated route management processor 11 exists, the route state and performance monitoring unit 12 forwards newest information about a state and performance of a route to the integrated route management processor 11.

The network route management processor 13 manages a route that is included in each network of the access network 100, the metro network 110, and the backbone network 120 on a network basis.

According to an exemplary embodiment of the present invention, when the network route management processor 13 manages the access route 200 of the access network 100, the network route management processor 13 manages a route list and sets, changes, or deletes a connection to a virtual local area network (VLAN) in a wired/wireless access network. Further, the network route management processor 13 controls the access route 200 according to a request of the integrated route management processor 11.

Management of the access route 200 by the network route management processor 13 may be multiplexly performed according to a network operation policy.

When the network route management processor 13 manages the metro route 210 of the metro network 110, the network route management processor 13 sets, changes, and deletes a packet transmission route of a line level based on connection-oriented carrier Ethernet technology such as a multiprotocol label switching-transport profile (MPLS-TP) or provider backbone bridge-traffic engineering (PBB-TE), and manages a route list of the metro network 110.

Further, the network route management processor 13 sets, changes, and deletes a virtual LAN route based on carrier Ethernet technology such as a provider bridge (PB) or a provider backbone bridge (PBB) in the metro network 110, and manages a route list of the metro network 110.

The network route management processor 13 controls a route by changing setting of a metro network node according to a request of the integrated route management processor 11. Management of the metro route 210 by the network route management processor 13 may be performed in a centralized type or a distributed type according to a network operation policy.

The backbone network 120 may be separated into a transmission network and/or an Internet protocol (IP) network and operated, and in this case, the network route management processor 13 sets, changes, and deletes an optical transmission route such as a synchronous optical network/synchronous digital hierarchy (SONET/SDH) or wavelength division multiplexing (WDM) in the backbone transmission network and manages a route list thereof.

Further, the network route management processor 13 controls an Internet protocol/multiprotocol label switching (I P/MPLS) technology-based label switching path (LSP) in the backbone IP network.

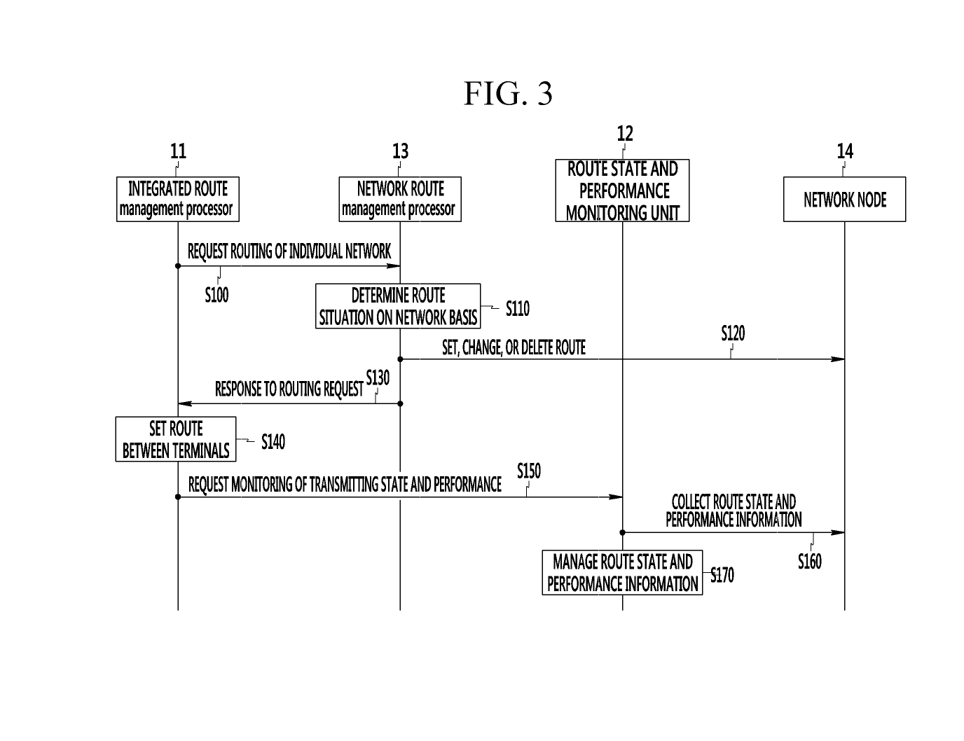

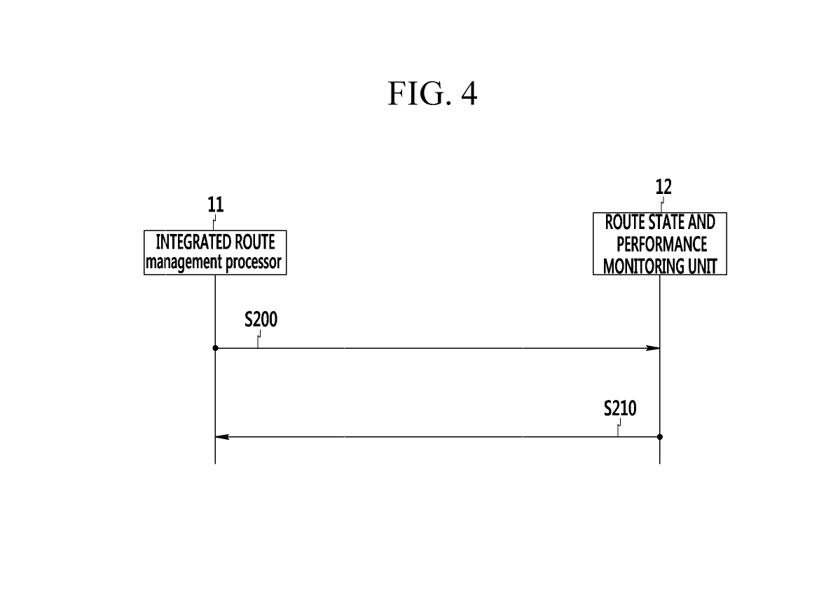

Hereinafter, a method of setting a route between terminals of a network using a multi-network integrated management system apparatus and a method of inquiring a QoS will be described with reference to FIGS. 3 and 4.

FIG. 3 is a flowchart illustrating a method of setting a route between terminals of a network through a multi-network integrated management system apparatus according to an exemplary embodiment of the present invention.

Referring to FIG. 3, the integrated route management processor 11, having received a user's network service request, requests routing of an individual network to the network route management processor 13 in order to set a route between multi-network terminals (S100).

The network route management processor 13, having received the routing request, determines a route situation of an individual network such as the access network 100, the metro network 110, and the backbone network 120 (S110).

Thereafter, the network route management processor 13 sets, changes, or deletes a route by controlling a network node 14 on a route that is included in each network according to a determining result of the step, thereby setting an optimal route of the individual network (S120).

As an optimal route that is set to the individual network, an existing available route may be continuously used, a new route may be generated and used, or a combination of the existing available route and the new route may be set as an optimal route.

When setting of an optimal route is terminated, the network route management processor 13 transmits a response to the request to the integrated route management processor 11 (S130).

Thereafter, the integrated route management processor 11, having received the response from the network route management processor 13, determines a correlation between optimal routes that are set to the individual network, combines an optimal route, and sets an optimal route between terminals that connect terminals (S140). In this case, the integrated route management processor 11 determines an optimal route of an individual network in order of a backbone network, a metro network, and an access network, and sets an optimal route between terminals.

Thereafter, the integrated route management processor 11 provides a network service based on a preset route between terminals of a multi-network to a user that requests a network service.

The integrated route management processor 11 stores and manages the preset optimal route between terminals and requests monitoring of a transmitting state and performance of an optimal route between terminals to the route state and performance monitoring unit 12 (S150).

The route state and performance monitoring unit 12, having received the monitoring request of a transmitting state and performance, collects information (transmitting state and transmission performance) about a route between terminals from network nodes 14 (S160).

In this case, information collection about a route between terminals of the route state and performance monitoring unit 12 may be periodically performed, and the route state and performance monitoring unit 12 analyzes and stores information about a route between collected terminals (S170).

FIG. 4 is a flowchart illustrating a method of inquiring a QoS through a multi-network integrated management system apparatus according to an exemplary embodiment of the present invention.

Referring to FIG. 4, the integrated route management processor 11, having received a request for a user's network QoS inquiry, requests a quality inquiry about a route to the route state and performance monitoring unit 12 in order to inquire on quality of a route between network terminals (S200).

The route state and performance monitoring unit 12, having received the request of the integrated route management processor 11, transmits information about a route between terminals including information about a route state or a route performance that is collected from the network nodes 14 to the integrated route management processor 11 (S210).

In this case, information about a route between terminals that is provided in the route state and performance monitoring unit 12 may include previously collected, analyzed, and stored information.

Thereafter, the integrated route management processor 11 transmits information about a route between terminals to the user, and thus a service inquiry through the multi-network integrated management system is complete, and the user can inquire a present quality condition of a providing network service.

In this way, according to an exemplary embodiment of the present invention, by integrating a management system apparatus of each network to a multi-network integrated management system apparatus, a route that is set to each network is integrally managed and thus a network service can be rapidly provided to a user.

Further, through monitoring of a traffic transmitting state and performance of a route between terminals, a present quality condition of a network service can be rapidly provided to the user.

In addition, a route between terminals that is set via a multi-network is easily controlled, and installation and maintenance cost of a management system can be reduced.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An integrated route management system apparatus of a multi-network, the integrated route management system apparatus comprising:
a network route management processor that manages a route that is included in an individual network of the multi-network;
a route state and performance monitoring unit that collects information about route state and route performance from a network node that is included in the route; and
an integrated route management processor that sets a route between terminals of the multi-network based on the route that is included in the individual network.

2. The integrated route management system apparatus of claim 1, wherein the network route management processor manages an access route that is included in an access network of the multi-network by setting, changing, or deleting a virtual LAN connection of the access network.

3. The integrated route management system apparatus of claim 1, wherein the network route management processor manages a metro route that is included in a metro network of the multi-network by setting, changing, or deleting a packet transmission route of a line level based on connection-oriented carrier Ethernet technology.

4. The integrated route management system apparatus of claim 3, wherein the network route management processor manages the metro route in a centralized type or a distributed type according to a network operation policy.

5. The integrated route management system apparatus of claim 1, wherein the network route management processor manages a backbone route that is included in a backbone network of the multi-network by setting, changing, or deleting a label exchange route or an optical transmission route.

6. The integrated route management system apparatus of claim 1, wherein the route state and performance monitoring unit periodically collects and stores information about the route state or route performance.

7. The integrated route management system apparatus of claim 1, wherein the integrated route management processor determines an optimal route of an individual network in order of a backbone network, a metro network, and an access network of the multi-network, when a user of a network service requests a network service, and sets a route between terminals based on the optimal route.

8. The integrated route management system apparatus of claim 1, wherein the integrated route management processor receives information about a route between terminals including information about route state or route performance from the route state and performance monitoring unit and provides the information to a user, when a user of a network service requests inquiry of a network QoS.

9. A method of setting a route between terminals through a multi-network integrated route management system apparatus, the method comprising:
receiving a preset optimal route of an individual network from a network route management processor of the integrated route management system apparatus; and
setting a route between terminals of a multi-network by combining the preset optimal route.

10. The method of claim 9, wherein the optimal route of the individual network is set based on a route situation of the individual network in which a network route management processor of the integrated route management system apparatus determines.

11. A method of inquiring a network QoS through a multi-network integrated route management system apparatus, the method comprising:
periodically collecting information about a route state and route performance from a network node of the multi-network; and
providing, when a request for a network QoS inquiry of a network user exists, information about a route between terminals comprising the collected information.
